(19) United States
(12) Patent Application Publication
(10) Pub. No.: US 2016/0335298 A1
(43) Pub. Date: Nov. 17, 2016

(54) METHODS, SYSTEMS, AND NON-TRANSITORY COMPUTER READABLE MEDIA FOR GENERATING A TREE STRUCTURE WITH NODAL COMPARISON FIELDS AND CUT VALUES FOR RAPID TREE TRAVERSAL AND REDUCED NUMBERS OF FULL COMPARISONS AT LEAF NODES

(71) Applicant: EXTREME NETWORKS, INC., San Jose, CA (US)

(72) Inventors: William Thomas Haggerty, Dunstable, MA (US); Stephen Henry Negus, Windham, NH (US)

(21) Appl. No.: 14/710,534

(22) Filed: May 12, 2015

(51) Int. Cl. G06F 17/30

(52) U.S. Cl. CPC G06F 17/30327; G06F 17/30528; G06F 17/30545

(57) ABSTRACT

A method for generating a tree structure with nodal comparison fields and cut values for rapid tree traversal and reduced numbers of full information item comparisons at leaf nodes is disclosed. The method is implemented in a computing device including a processor and a memory.

The method includes receiving, by the processor, an information item set for processing information units. The method further includes selecting, by the processor, fields in the information item set and determining distribution frequencies of values of the fields. The method further includes using, by the processor, the distribution frequencies to assign cut values and comparison fields to non-leaf nodes in the tree structure. The method further includes assigning, by the processor, information items in the information item set to leaf nodes in the tree structure using the cut values and the comparison fields.

### TECHNICAL FIELD

The subject matter described herein relates to processing information. More particularly, the subject matter described herein relates to methods, systems, and non-transitory computer readable media for generating and using a tree structure with nodal comparison fields cut values for rapid tree traversal and reduced numbers of full comparisons at leaf nodes.

### BACKGROUND

Computing devices, such as network packet processing devices, are often required to match information with sets of prioritized lists or data structures such as rules to classify or otherwise process the information. For example, network packet processing devices match incoming packets or frames with rules in a prioritized set of information items, that in one example are rules. The term “packet” is used herein to refer to any discrete unit of information including, but not limited to packets or frames corresponding to one or more open systems interconnect (OSI) layers. The application of the information items to an incoming packet includes comparing portions of the packet to corresponding portions of each information item to locate the highest priority matching information item that governs processing of the packet. Examples of processing operations that need to be performed for some network packets include policy application, route lookups, address resolution protocol (ARP) resolution, etc.

One possible way to apply a prioritized list of items such as rules to packets is to compare each field value in each packet to each field value in every rule in the list to locate the highest priority match. While such a method would accurately locate the highest priority matching rule, such a method is inefficient and unscalable as the number of rules increases. For example, many packet processing devices are required to process packets or frames at line rates, which currently can be on the order of terabits per second. If each packet is compared to every rule in the rule set, line rate processing may not be possible for large rule sets. Another possible solution to the problem of identifying the highest priority rule that matches a packet is to use hardware such as a ternary content addressable memory (TCAM) to classify the packets. TCAMs have the advantage of being able to match data with some bits specified as “don't care” values. However, using the TCAMs can be cost prohibitive as the number of rules increases.

Yet another possible solution to the problem of identifying the highest priority rule that matches a packet is to use a hash table. However, problems with using a hash table include the fact that a rule must have all fields explicitly defined, not allowing for ranges or wildcards. In addition, because the set of hashable fields may differ from one rule to the next, hashing that requires a hash table that operates on the same set of fields for each packet will not work in such a scenario. The same issues prevent other tree building mechanisms, such as Anderson-Velsky and Landis trees (AVLs) from working on a prioritized set of rules where the fields that are used can match particular rules vary.

Accordingly, there exists a need for methods, systems, and computer readable media for generating a tree structure with nodal comparison fields and cut values for rapid tree traversal and reduced numbers of full comparisons at leaf nodes.

### SUMMARY

Methods, systems, and non-transitory computer readable media for generating a tree structure with nodal comparison fields and cut values for rapid tree traversal and reduced numbers of full rule comparisons at leaf nodes are provided. The subject matter described herein utilizes distribution frequencies embodied in histogram structures to select comparison fields and cut values for non-leaf nodes in a tree structure. The comparison fields and cut values are stored at or associated with the non-leaf nodes, rather than storing entire rules at the non-leaf nodes. For each comparison field/cut value combination, rules are divided among child nodes of each non-leaf node. During tree traversal, the comparison at each non-leaf node includes using the comparison field to select a corresponding field from an information unit and comparing the value of the field to the cut value. Full rule comparisons occur at the leaf nodes. However, because the number of rules at the leaf nodes is reduced from the original rule set, the number of full rule comparisons is reduced and hence the processing time for classifying information units is reduced.

In one example, if a rule set includes a list of residence addresses starting with the street number 1000 and evenly distributed between 1000 and 2000, and the comparison field is for a given node is selected to be the street number, then an ideal cut value for the dividing the rules among left and right child nodes of the node would be 1500. The subject matter described herein selects a comparison field and an optimal cut value for each non-leaf node in a tree structure, where the optimal cut value is the value that results in the most balanced division of rules between child nodes and the shortest resulting branches.

Although the examples described herein relate primarily to selecting numeric cut values, the subject matter described herein is not limited to numeric cut values. A cut value, as described herein, is intended to refer to any unit of information that can be quantized and compared with corresponding information that is being classified.

A method for generating a tree structure with nodal comparison fields and cut values for rapid tree traversal and reduced numbers of full rule comparisons at leaf nodes is disclosed. The method is implemented in a computing device including a processor and a memory. The method includes receiving, by the processor, an information item set for processing information units. The method further includes selecting, by the processor, fields in the information item set and determining distribution frequencies of values of the fields. The method further includes using, by the processor, the distribution frequencies to assign cut values and comparison fields to non-leaf nodes in the tree structure. The method further includes assigning, by the processor, information items in the information item set to leaf nodes in the tree structure using the cut values and the comparison fields.

The subject matter described herein may be implemented in hardware, software, firmware, or any combination thereof. As such, the terms “function” “node” or “module” as used herein refer to hardware, which may also include software and/or firmware components, for implementing the feature being described. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The subject matter described herein will now be explained with reference to the accompanying drawings of which:

FIG. 1 is a block diagram illustrating an exemplary system for generating a tree structure with nodal comparison fields and cut values for rapid tree traversal and reduced numbers of full rule comparisons at leaf nodes according to an embodiment of the subject matter described herein;

FIG. 2 is a tree diagram illustrating an exemplary division of rules between left and right nodes using cut values according to an embodiment of the subject matter described herein;

FIG. 3 is a tree diagram illustrating an example of a tree structure with four levels referencing a reduced number of rules assigned to leaf nodes according to an embodiment of the subject matter described herein;

FIG. 4 is a table of exemplary source IP addresses from which cut values for a packet classification tree can be selected according to an embodiment of the subject matter described herein;

FIG. 5 is a table illustrating the separation of the addresses in FIG. 4 into different fields, where each field corresponds to one byte of each address;

FIG. 6 is a graph of value of the first byte of each address from the table illustrated in FIG. 5;

FIG. 7A is a diagram of a histogram structure implemented using an array that stores a distribution frequency of the values of the first byte of the address illustrated in FIG. 6;

FIG. 7B is a tree diagram illustrating the division of rules between left and right child nodes after selection of the first byte of the addresses as the comparison field and a cut value is selected using the histogram structure illustrated in FIG. 7A;

FIG. 8 is a table illustrating network addresses corresponding to packet rules where some of the rules have ranges of matching values; FIG. 9 is a graph of the values of the last byte of the addresses illustrated in FIG. 8;

FIG. 10A is a diagram illustrating a histogram structure implemented using an array that stores the distribution frequency of the last byte of the addresses illustrated in FIG. 9;

FIG. 10B is a tree diagram illustrating the division of rules among left and right child nodes when the last byte of the address is selected as the comparison field and a cut value is selected using the histogram structure illustrated in FIG. 10A; and

FIG. 11 is a flow chart illustrating an exemplary process for building tree structure with nodal comparison fields and cut values for rapid tree traversal and reduced numbers of full rule comparisons at leaf nodes according to an embodiment of the subject matter described herein.

### DETAILED DESCRIPTION

The subject matter described herein includes methods, systems, and computer readable media for generating a tree structure with nodal comparison fields and cut values for rapid tree traversal and reduced numbers of full rule comparisons at leaf nodes. The subject matter described herein assumes that a rule set contains a prioritized list of rules. A prioritized list of rules means that the rules in the list are arranged in a priority order, either explicitly or implicitly. The rules may have specific matching fields, where a single value of the field or set of fields is compared to a corresponding portion(s) of information to be processed. Other rules may have generalized matching fields that match ranges of values. Still other rules may have specified or unspecified matching fields that match any value, typically referred to as “wildcards”. The mechanisms described herein tend to be optimized for prioritized items or rules but also are effective for other searches, matches or lookup types.

As stated above, one possible mechanism for processing information units using a prioritized list of rules is to compare all of the field values in an information unit to all field values in each rule in a rule set until a match is located or the end of the rule list is reached. If the field values in a rule match all of the corresponding field values in the information unit, then the result is a match. If the field values in the rule do not match all of the corresponding field values in the information unit, the process is repeated for each additional rule in order of descending priority. The comparisons are continued until a match is located or the end of the list of rules is reached. Problems with this mechanism include delays caused by the number of number of comparisons required in comparing each field value in the information unit to each corresponding field value in each rule until a match is located or the end of the list is reached and the fact that some information units, such as packets, must be processed at a very high rate to meet packet line rates or other acceptable processing speed requirements. In addition, some packets have many fields and different layers that may require comparisons. Problems with using hashing or AVL trees include the inability to work on ranges and wildcards and the inability to define rules that operate on different fields in a packet or different IU types.

One goal of the subject matter described herein is to find a mechanism that is faster than walking through the entire prioritized list of rules for each information unit by minimizing the number of rules for which each of the field values must be compared to each of the field values in an information unit. Other goals include optimizing lookup performance, minimizing memory consumption, and finding a software solution in lieu of cost prohibitive hardware, such as TCAMs. However, the subject matter described herein is not limited to being implemented in software. The mechanisms described herein will work equally well, if not better, with some or all parts implemented in hardware.

### Approach

One aspect of the subject matter described herein includes a process for building a tree data structure, typically, a binary tree that will result in a reduced set of matching rules at the leaves of the tree. The approach is to intelligently split the rules that need to be searched into multiple smaller sets, where the smaller sets are each attached to a different leaf of a binary tree. The binary tree should have the best possible balance, the minimum depth required and simple test conditions at each node to quickly branch. The tree will need to be fully traversed to a leaf node each time any rule would need to be applied to an information unit. This tradeoff of always needing to traverse the tree is made up for in the reduced set of rules needing to be fully inspected at the leaf nodes. The tests made at each node of the tree are ideally small and fast, perhaps 10-100 times faster than a single match of any one rule at the leaf nodes. The “longest rule list” at a leaf node will determine the worst case rule lookup time. This directly translates to the longest packet processing time and therefore to the maximum supported packet arrival rate. The need to limit the longest rules list at the leaf nodes drives the need for a balanced tree. Adding levels to the tree may divide the rule set into smaller lists at the leaf nodes, or perhaps not, depending on the makeup of the rule set, as some sets cannot be split without duplicating rules in each child set. A great deal of effort can and should be taken to build an efficient tree. This can be an ongoing background task even while the tree is in use. As the tree structure only changes when the rules change (typically via network management or policy changes by administrator) the rate of building the tree can be many orders of magnitude slower than the need to traverse the tree, which typically happens at packet receive rates in switches and routers.

### Balancing the Tree

In order to build a balanced tree we need to select a mechanism to the split our rules most evenly. Fields in our rule list may be defined, typically based on the structure of the rules themselves. Each field can then be examined, including the values of the fields for each and every rule in the rule set. Given a rule set for which all values of a field can be examined it may be found that the field can be used to evenly divide the rule set based, not on the midpoint of the field, but based on the median of the values used in the rules for that field. As an example, a byte-wide field may support 256 values, the rules in the rule set, however, may have only values from 1 to 63 with a median of 40 (equal number of rules on either side of 40). In this example 40 would be defined as the cut value for that field. If therefore this field was used in the tree and the value of 40 was used as the tree node test-point value, half the rules could be placed on each child node.

### Comparison Fields

The term “comparison field” will be used to describe a field from the rules in the rule set that is selected to be used to divide the rule set. Comparison fields for the rule set are used to build the tree structure to contain the rules at the leaf nodes. A field from the rules of the rule set is most likely used as a comparison field if the values for that field in the rule set allow the rules to be split most evenly by a test of that field and the specific “median value” at a tree node. All fields may be considered to find a best match for the most even split of the rule set. The rules then are divided on that field and cut value of the field of and assigned to their respective child nodes. Each respective rule subset is assigned to the child nodes. The “comparison field/cut value” selection process is then repeated for each child rule subset. The new found comparison field and cut value are used to further split the rules set. This continues until a subset of the subset of the rules is left for testing at each leaf node.

Fields in the rule set are typically but not necessarily present in the information unit. As information units are checked for rules matches, the field value corresponding to the comparison field is extracted from the information units for the tree node in question, and, based on the value, a child node is chosen. Using such comparisons at each node, the tree is traversed to the rule set subset at each leaf node. Rules found at the leaf node are traversed in priority order until a match is found or the leaf node's rule subset is exhausted. Comparison fields stored at each node in the tree may include all or portions of fields used in packets or information units of any OSI layer, including Ethernet frames, such as IEEE 802.3 frames, IP packets, TCP, UDP, SCTP or other layer 3 protocol data units, and application layer protocol data units. A comparison field may be as small as a single bit of a field in a protocol data unit. A comparison field may even blur defined boundaries of a protocol field or may in fact be any combination of bits in the rule set, for example, a combination of bits that spans multiple different fields.

Some typical comparison fields for use might include the Medium Access Control (MAC) addresses, network addresses, such as IPv4 or IPv6 addresses or portions or combinations of some or all, protocol type (TCP, UDP, SCTP, etc.) and others. Each of these fields is comprised of some number of bits or bytes (IPv4 addresses have 4 bytes, IPv6 addresses may have 16 bytes, MAC/Ethernet addresses have 6 bytes, and so on). In a typical network, many of the values used in certain fields are often repeated in every packet which makes those fields less desirable when building a tree. For instance, it is not uncommon for all IP addresses in a network to be in the 10.a.b.c format. If all of the “10” network rules went to one side of the tree, using the highest order byte of the IP address as the comparison field would not be as useful because all of the rules would be on the same side of the tree.

### Tree Attributes

In one embodiment, a binary tree that implements a rule set may not use any of the rules at the tree nodes, just a comparison field containing from 1 to “N” bits in length and the value to test against the field to make the decision on which child node branch to take. In one exemplary implementation of the subject matter described herein, each node in the tree contains a pair of values that indicate which byte in the information unit (the comparison “field”) to examine and what value to compare it to (the cut value). It is typically faster to compare a single byte value than other field/value sizes at each node of the tree, but this will vary with implementation details such as hardware assist. Typically the smaller the field, the faster the field value can be compared with information unit data. In turn, the less data that has to be used, the better the memory and the central processing unit (CPU) performance.

In a second approach, it is possible to define 2 separate trees and use a simple approach to separate (perhaps in hardware) the information units, packets or received frames in this example, for processing into each respective tree. Examples may include hardware to separate packets into unicast and broadcast/multicast receive queues. Each queue utilizes a separate tree for rules processing. Alternately, packets may be split based on IPv4 processing versus IPv6 with separate trees and rules for IPv4 processing and IPv6 processing. Other packets (neither IPv4 nor IPv6) might have a third tree or share the lesser used of the two trees with that protocol rule set. Benefits of these approaches may be:
hardware assist for the splitting of the packets to the separate trees,
dedicated processors to each separate trees,
hardware assist logic for tree traversal,
hardware assist or dedicated processors to gather the fields used in the tree from the packets, and/or,
hardware assist or dedicated processors to any/all processes in the task set,
judicious use of TCAMs for the longest leaf node rule subset(s)

### CPU Operations

In one implementation, information unit processing lookups using a tree structure as described herein may be performed by a CPU. The CPU may perform a memory read operation to extract data from the tree structure to be compared with data from information units to be classified or otherwise processed. In most computing systems, the maximum number of bytes that can be retrieved by a memory read operation may be limited, such as a burst read operation. Accordingly, it is desirable to minimize the size of the tree structure to reduce the amount of data that needs to be retrieved during packet rule classification procedures.

At each node in the tree, the CPU needs to determine the comparison field indicated by the node, retrieve the corresponding value from the packet, and compare the value from the packet with the cut value stored in the node. If the tree node has 2 bytes of data one each for the cut value and comparison field, for example and the data can be read 10 bytes at a time, then one read operation can retrieve data for 5 tree nodes of data for comparisons. The less data per node, the more nodes that can be retrieved per read operation. Reducing the number of bytes needed by the comparison reduces the number of reads it takes to get the data. The operation of reading and storing data from a plurality of nodes in the tree is referred to as a cache line read in some systems. These cache line reads are very time-expensive operations.

### Comparisons

Rules will have a defined or implied value. The value in the rule can be a single value, a range of values or any value, in the case of a wildcard. Selected fields and values contained therein from information units are compared to the same field/value defining the node in the tree. “Less than or equal” results are considered to be left of the cut, “Greater than” results are to the right. In our exemplary implementation, comparisons in the tree may result in either a “left” or a “right” decision only.

In one exemplary implementation, during tree traversal, a pair of bytes is retrieved from a node. The first byte of the node pair is used to retrieve from the IU the information at that byte position in the IU (i.e. if the value is 22 then the byte at position 22 in the IU is retrieved). The retrieved byte is then compared to the cut value and the “left-right” decision made. Each node is subsequently similarly traversed to a leaf node.

### Example Computing System

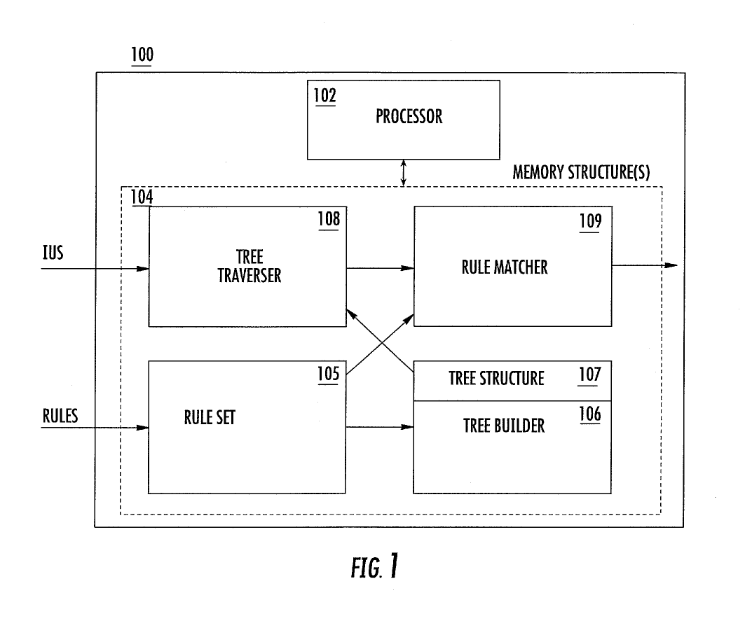

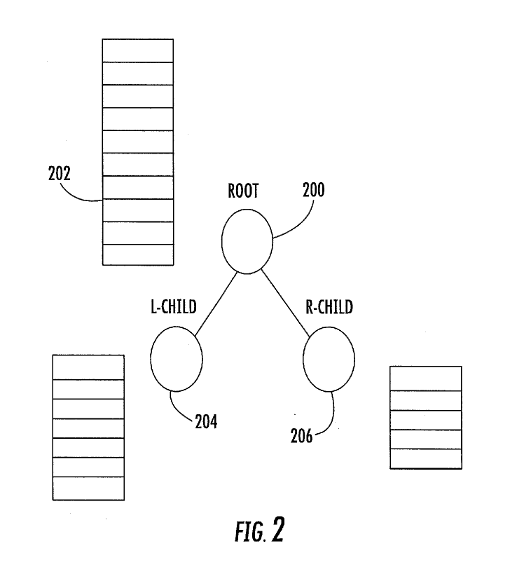

FIG. 1 is a block diagram illustrating an exemplary computing device for creating and using a tree structure with comparison fields and optimally selected cut values according to an embodiment of the subject matter described herein. Referring to FIG. 1, computing device 100 includes a processor 102 and a memory 104. Processor 102 may be a microprocessor that executes instructions and accesses data stored in memory 104. In the illustrated example, the data stored in memory 104 may include a rule set 105. Rule set 105 contains the rules used to classify packets. A tree builder 106 constructs a tree structure 107 from rule set 105. As stated above, tree structure 107 may be generated using distributions frequency of use of the values of fields in the rules to select a comparison field and a cut value for each non-leaf node in tree structure 107. The comparison fields and cut values assigned to the nodes in tree structure 107 may be used to divide rules among leaf nodes. Full rules may be assigned to leaf nodes in tree structure 107.

When an information unit to be classified is received, a tree traverser 108 traverses tree structure 107 by, for each non-leaf node, using the comparison field to extract a corresponding field value from the information unit, comparing the field value from the information unit to the cut value for the node, and proceeding to one or the other child nodes of the node based on the relationship of the value from the information unit to the cut value. Tree traverser 108 repeats this process until a leaf node is reached. When a leaf node is reached, rule matcher 109 performs full rule comparisons for the rule sub-lists stored at the leaf node to the corresponding field values from the information unit. Performing a full rule comparison includes comparing each value in each rule in the rule sub-list to each corresponding value in the information unit until a match is located. The rule sub-list at each leaf node may be arranged such that the rules are compared in priority order to the information unit, and the first match located will therefore be the highest priority match.

In one embodiment, computing device 100 may be a general or special purpose computer that builds tree structure 107 by selecting comparison fields and cut values from the rules, assigning the comparison fields and cut values to non-leaf nodes in tree structure 107, and assigning the relevant rules to leaf nodes of tree structure. Tree structure 107 would contain a comparison field and a cut value for each non-leaf node in tree structure 107 and the rules, or a link to the rules, attached at each leaf node. In one specific example, computing device 100 may be a packet processing device that processes received packets using a tree structure to look up the rules of an Access Control List (ACL).

Tree builder 106 receives as input classification or lookup rules and builds tree structure 107 by selecting a comparison field and a cut value for each non-leaf node in tree structure 107. This process attempts to split the rules in the most balanced manner possible between left and right branches of tree structure 107 emanating from a non-leaf node. All fields may be considered in determining what field to use as the comparison field at each node. If multiple field/cut values pairs result in equal distributions of rules then the comparison field and cut value that produce the shortest branch when looking at the actual depth of tree structure 107 might be selected by the tree builder 106, but the goal is typically to produce the smallest rules list at each leaf node. Examples of trees and comparison field/cut value selections for the trees will be described in detail below. Tree builder 106 is capable of selecting comparison fields and cut values when rules correspond to individual values in packets or ranges of field values. Comparison field selection may be based solely on the field definition in the rules presented (e.g., selecting the field that varies most uniformly among the rules) or chosen, computed, or arranged based on implementation (hardware acceleration, TCAM, etc.) or other mechanisms or IU organizational knowledge.

As IUs or packets are received for processing, the fields in the IU which correspond to the fields used to build the tree are retrieved from the IU by tree traverser 108. Fields from an IU to be compared to cut values at different nodes in tree structure 107 may be read from memory one field at a time (i.e., once for each non-leaf node encountered during tree traversal) or in a bulk read where plural fields to be (or possibly be) compared at different nodes in the tree are obtained in a single read operation. The IU field values are used to traverse the tree to a leaf node. At each leaf node is a rule list, hopefully a small subset of the complete rule set. The rules in the rule list at each leaf node will be compared in priority order to the complete set of IU field values for the IU for which the tree has been traversed to a given leaf node. It should be noted that the IU field values used to traverse the tree may be (and hopefully are) a subset of the IU field values compared to the rules at each leaf node. Rule matcher 109 is used to compare the actual rules attached to the leaf node to the IU or packet. The output from the operations of tree traverser 108 and rule matcher 109 may be further processed or used directly to help classify the IU or packet. Other processing may also be performed such as sending a packet to a forwarding, routing, logging, security or policing function. The rule matching function may also select packets to be locally or remotely mirrored as define by the rules or by exception.

While the components illustrated in FIG. 1 are generally shown as memory resident structures, any or all of them may be created, held or operated in hardware, firmware, logic or other suitable environment. Further, some or all of the components illustrated in FIG. 1 may be held independently or separately from the other components, i.e., the rules in rule set 105 may be held or stored centrally on a server separate from computing device 100. Rule matcher 109 may be implemented in dedicated hardware.

### Building The Tree

In order to initiate building of tree structure 107, it is first necessary to select the comparison field for the root node for the tree. The comparison field selected for the root node may be a combination of one or more bit positions whose values are capable of dividing the rule set mostly evenly among left and right branches. For example, a particular protocol field has value that is evenly distributed between 1 and 10 in the rule set, then that protocol field may be selected as the comparison field for the root node and 5 may be selected as the cut value for the root node.

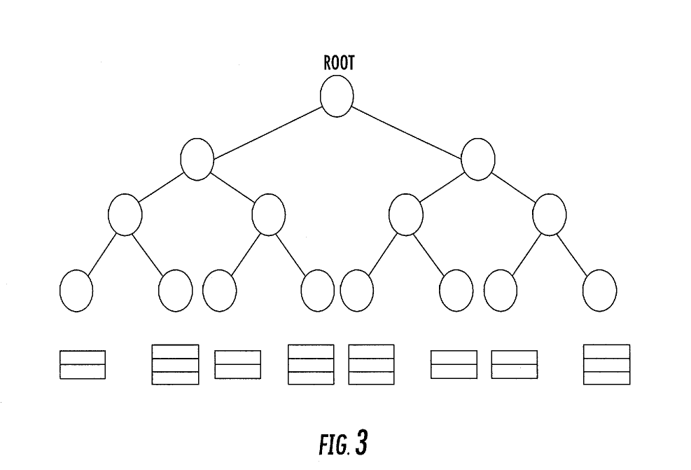

FIG. 2 illustrates graphically the selection of a comparison field and a cut value for the root node. In FIG. 2, root node 200 stores a comparison field and cut value combination that most evenly divides a set of ten rules 202 among child nodes 204 and 206. The process of selecting the comparison field and cut value for the root node may include analyzing rules 202 and selecting, in one example, a field/cut value combination that divides rules 202 among left and right children 204 and 206 in the most balanced manner possible with the shortest branch depth. In the illustrated example, the original rule set is split 7 to 5 between the left and right child nodes. The number of rules in the split rule subsets may not be equal to the number of rules in the original rule set, for example, because rules with ranges may require some rules to be added to both child nodes.

The process of selecting the best comparison field and cut value combination for a given node in the tree includes selecting the best field/cut value combination that results in the best balance of unique rules that go in left and right branches as a primary metric. As a secondary metric, if multiple field/cut value combinations seem equally good, one approach might select the field/cut value that produces the shortest branch when looking at the actual depth of the tree (shorter trees traverse faster). Each non-leaf node in the tree contains a field/cut value combination. In one implementation, each comparison field value stored at the non-leaf nodes in the tree structure is understood to reference a byte wide field in an IU and is a number that indicates which byte (offset byte) to retrieve from the IU. For example, if the comparison field stored at a tree node is 1, the first byte from an information unit is compared to the cut value associated with the node. Thus, in this example, the node is defined by a 2 byte pair. Each leaf node contains a subset of the original rule set where each rule in the subset is to be compared in its entirety with the corresponding fields in the information unit to be processed or classified. The original rule set is divided by applying the tree parameters (i.e., the comparison field and cut value for each node) to split the rule set into a left table and a right table, as illustrated by the left and right rule subsets in FIG. 2.

The process of selecting comparison fields and cut values is repeated for the left and right child nodes which were created from the root. The original node combination has grouped a portion of the rules based on a selected field to the left and right. These groups of left and right rules are not contained in the tree. During the tree building process, they are, however, examined as two new lists and are used to build the child node field/cut value parameters.

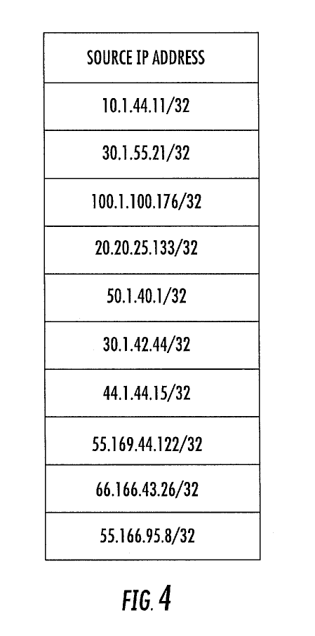

As was performed at the root node, a comparison field and cut value combination is selected for the left and right lists. Each time a split is made, the list of rules that a node references is divided into left and right rule subsets with typically a reduced number of rules for each child node. As the comparison field and cut value combinations are selected, the rules in each subset are maintained in the original priority order (or the priority of each rule is retained so that full rule comparisons can occur in priority order). The number of rules at the lowest level of the tree is a function of how many levels are present in the tree, how evenly the rules may be divided and if the rules can be divided/further divided. Each level of the tree potentially reduces of the number of rules referenced to a single node by 50%, half to each of the left and right child nodes. FIG. 3 illustrates an example of a tree with four levels referencing a reduced set of rules at each lowest level node. In FIG. 3, the lowest level or leaf nodes in the tree include two or three rules, which results in a reduced number of comparisons over an implementation where the complete set of matching rules is potentially compared to each packet, potentially 20 rules in this example.

### Example of Comparison Field and Cut Value Selection Using Source IP Addresses

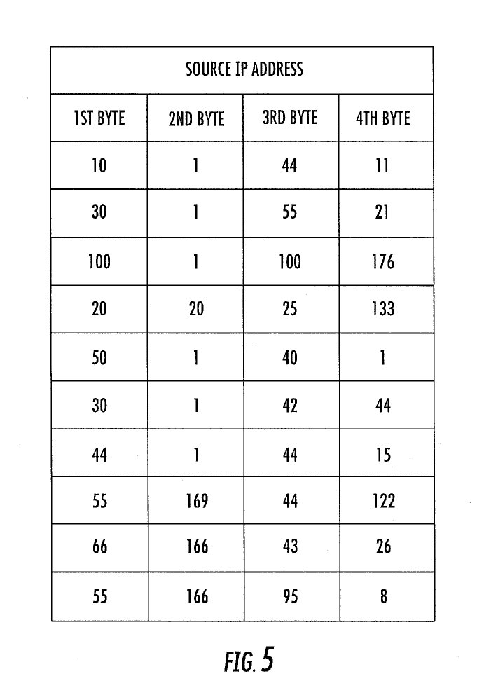

In order to illustrate the method of selecting comparison fields and cut values described herein, an example using source IP addresses will now be presented. FIG. 4 is a table illustrating source IP addresses where each source IP address(es) corresponds to a packet classification rule. In FIG. 4, the source IP addresses are shown in dotted decimal notation with a 32 bit mask for each address indicating the entire 32 bit address corresponds to each rule. In the illustrated example, the first byte in each rule/address is selected as the field to evaluate as a potential comparison field.

All fields in the rule set or a subset of the fields may be evaluated to select a comparison field and cut value for a particular tree node. For example, in FIG. 4, each byte of the IP addresses may be evaluated as a potential comparison field for dividing the rule set. To select a comparison field, as will be described in more detail below, distribution frequencies of the values of the fields in the rules being evaluated are determined. From each distribution frequency, a cut value is selected and the resulting division of rules is analyzed. The field/cut value combination that most evenly divides the rule set among child nodes may be assigned as the comparison field and cut value to a given node.

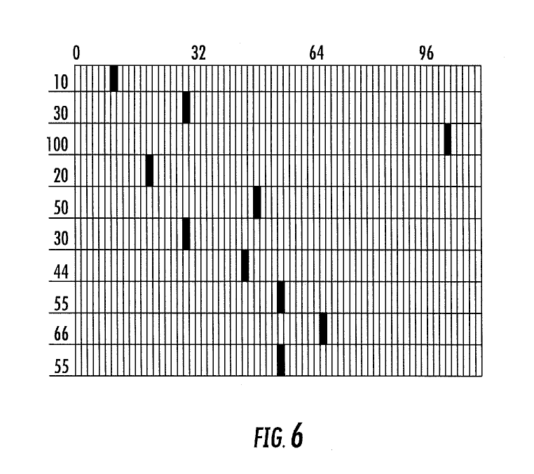

In the following example, the first byte of the IP address rule set illustrated in FIG. 4 is evaluated by determining the distribution frequency of its values and selecting a cut value. FIG. 5 illustrates the IP addresses from FIG. 4 where the IP addresses are subdivided according to bytes. In this example, a cut value will be selected for byte 1 (the most significant byte), indicated by the first column in the table in FIG. 5. The process of selecting a potential comparison field and a cut value for the field may be repeated for each of the remaining bytes in the IP addresses, and the combination that most evenly divides the rule set may be selected as the cut value and comparison field for a given tree node.

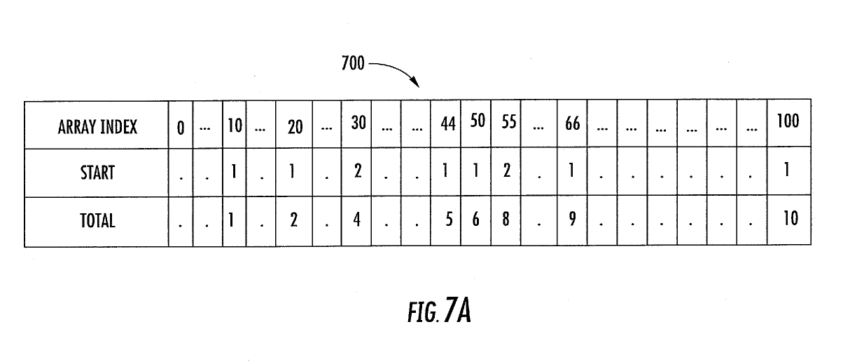

FIG. 6 graphically illustrates the distribution values of the first byte of each IP address from the tables in FIGS. 4 and 5. Because the first byte has 8 bits, the binary values could range from 0 to 255. However, in this example, the largest value of the first byte of any of the rules is 100 and thus the graph in FIG. 6 only show values of the first byte up to 100. In FIG. 6, the rows correspond to values of the first byte. Each row includes a mark that is spaced from “0” by an amount of cells equal to the value of the first byte. Graphically selecting the best cut value includes drawing a vertical line through all the rows in the graph that results in balanced numbers and marks on the left hand side and the right hand side of the line. Computationally, such an operation can be performed by creating a construct referred to herein as a histogram structure that stores a distribution frequency of the values of the field being evaluated. In one example implementation, the histogram structure is an array having indices that store counts of the frequency of occurrence in the rule set of a given value of the field being evaluated.

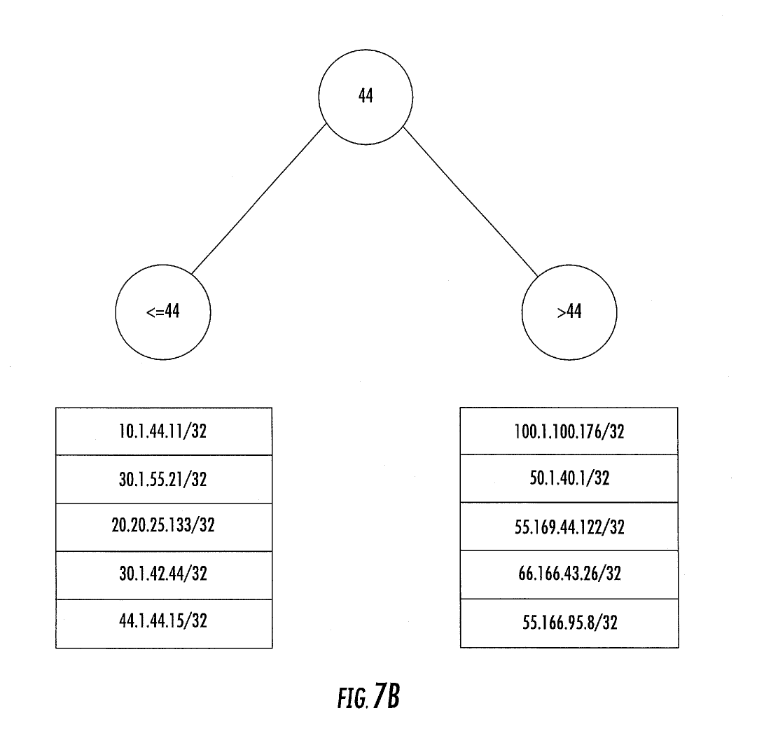

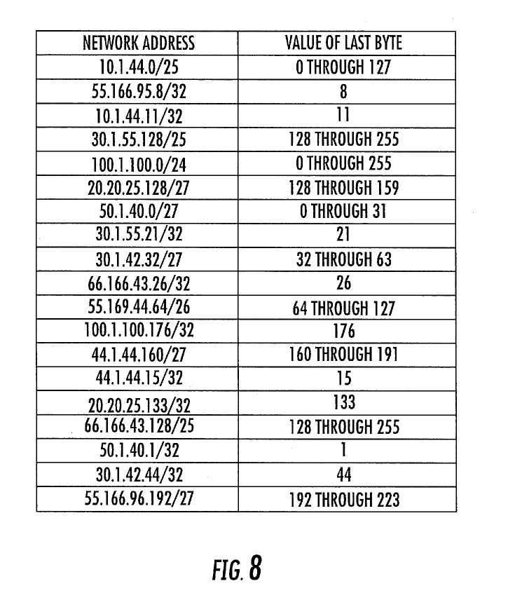

FIG. 7A is a diagram illustrating a histogram structure for the data in FIG. 6. In FIG. 7A, histogram structure 700 comprises an array, where array indices store numbers indicating the number of occurrences of rule value at that particular array index. For example, there is one occurrence of the value 10 in the first byte of the IP addresses in FIG. 6. Thus, array index 10 includes a value of 1 in the “occurrences” row. There are two occurrences of the value 55. Accordingly, the array index 55 indicates this with the number 2 in the “occurrences” row. The indices that do not correspond to values of the field being evaluated may contain zero or null values. These indices are represented by ellipses in FIG. 7A, and the null or zero values are indicated by dots.

Assuming no rules with ranges of values or wildcards, the cut value with the best balance between left and right branches can be found by traversing the array illustrated in FIG. 7A and accumulating the counts. Such accumulation is indicated by the row labeled “Total” in FIG. 7A. If one proceeds to the right from the first array index “0”, the total accumulated at array element 10 is 1, the total accumulated at array element 20 is 2, and so forth. The best cut value for this rule field is found when an accumulation equal to one half of the total number of rules is reached. In this example, the total number of rules is 10. Accordingly, when the accumulated count equals 5, which corresponds to array element 44, is reached, then the cut value of 44 is selected as the best cut value for that field for this rule set. Once an accumulated count of 5 is reached, this means there are 5 rules in which the first byte of the IP address is less than or equal to 44. Since there is a total of 10 rules, there are also 5 rules in which the first byte is greater than 44. Thus, 44 is selected as the best cut value for the first byte of the IP address and results in balanced branches of 5 rules on the left branch and 5 rules on the right branch.

Such a divided rule set is illustrated in FIG. 7B. In FIG. 7B, the root node includes the cut value 44. The left child node includes the 5 rules with byte values that are less than or equal to 44, and the right node includes the 5 rules with byte values that are greater than 44. In FIG. 7B, the tree is illustrated with the second level nodes being the leaf nodes, each having five rules. While dividing the rule set based on one comparison field/cut value combination is intended to be within the scope of the subject matter described herein, the process of selecting a comparison field and the best cut value for the node may repeated for the remaining bytes in the IP addresses in the rule set. The best comparison field and best cut value are installed at nodes non-leaf nodes in the tree. The leaf nodes each include a subset of rules to be compared with each of the field values (in this case the entire source IP address) in incoming packets.

Thus, when a packet to be classified is received by computing device 100, tree traverser 108 traverses the tree and uses the comparison field at each node to determine which field value to extract from the packet. The rule matcher uses the cut value at each tree node to compare to the field value selected from the packet. In this example, because the comparison field at the first level node in the tree specifies the first byte of the IP address, the rule matcher first looks at the first byte of the IP address in a received packet. If the first byte of the IP address is less than or equal to 44, then tree traverser 108 proceeds down the left branch of the tree. If the first byte of the IP address is greater than 44, then tree traverser 108 proceeds down the right half of the tree. At the next node, the tree matcher again extracts the appropriate field from the IU based on that node's comparison field and compares the IU field value to the cut value, and proceeds down the left or right branch based on the results of the comparison. Assuming a four level tree with one level corresponding to each byte in the IP address, the process is repeated four times—once at each level—until a leaf node is reached. The leaf node does not include a cut value or a comparison field. Instead, the leaf node includes a list of rules (in this case entire IP addresses) to which the IP address in the packet must be compared. Without such an arrangement, the four bytes in the IP address in the packet would have to be compared to the four bytes in every rule in the list until an exact match is found or the end of the list is reached.

### Rules with Ranges

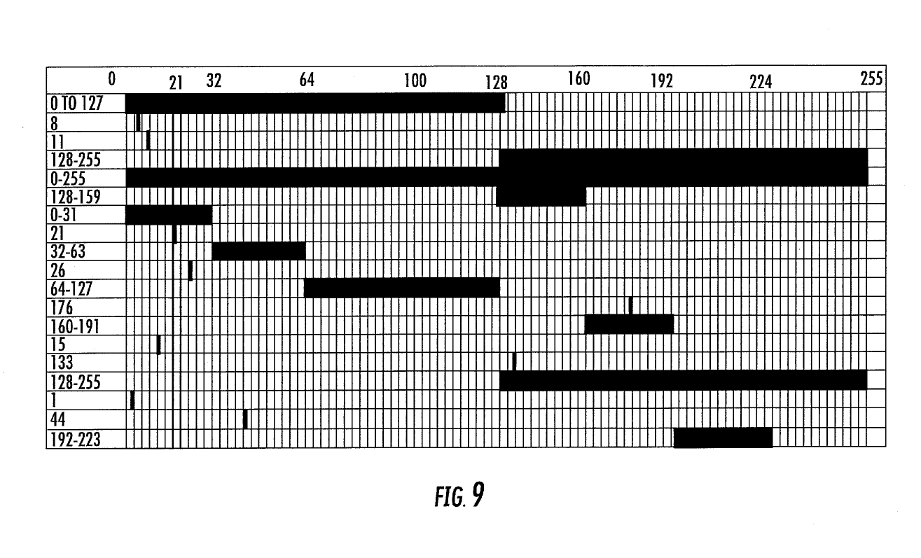

In addition to being able to select comparison fields and cut values for fields with specific or single values, tree builder 106 is capable of selecting the best cut values for rules that include ranges or wildcards. FIG. 8 is a table that illustrates rules with ranges of values or wildcards. The table in FIG. 8 includes individual IP addresses similar to FIG. 4 and adds additional IP addresses where some of the rules match ranges of source IP addresses. For example, the first IP address of the table is 10.1.44.0/25. 10.1.44.0 is the lowest address in the range. “/25” specifies a 25 bit bitmask starting from the most significant bit of the address, which leaves 7 bits to specify the range. The range of possible values for 7 bits is 0-127. Thus, the first entry in the table matches IP addresses ranging from 10.1.44.0 to 10.1.44.127.

As before, the goal is to select comparison fields and to find the value that represents the best cut that balances the rules into left and right branches of the tree with the fewest rules at each leaf node. FIG. 9 graphically illustrates the rules and the relative locations of the rule field values. In FIG. 9, the rules that correspond with individual values are indicated by a single mark in a row corresponding to that value. The rules that correspond to ranges of values are shaded in the rows with values that correspond with each of the ranges. In this example, the fourth byte of the IP address is being reviewed to determine the best cut value for that byte. If an entry corresponds to a range of values, the range has a start value and an end value. For example, the start value for the first rule in the table is 0 and the end value is 127. If the entry or rule corresponds to an individual value, that value is considered to be both the start and end value. For example, for the second rule in the table, the start and end value is 8. Thus, by considering single-valued rules as having ranges that start and end at the single value, the tree building mechanism described herein is capable of selecting the best comparison fields and cut values for rules with single values, ranges, and wildcards.

The process of selecting a comparison field/cut value combination includes recording the number of entries that have the same start values at each possible value of the rule field and also recording the number of entries that have the same stop value at each possible value of the rule.

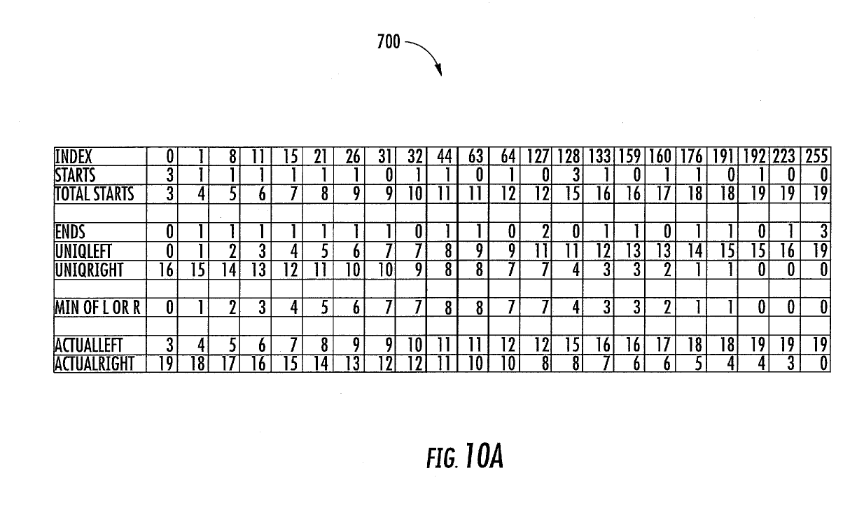

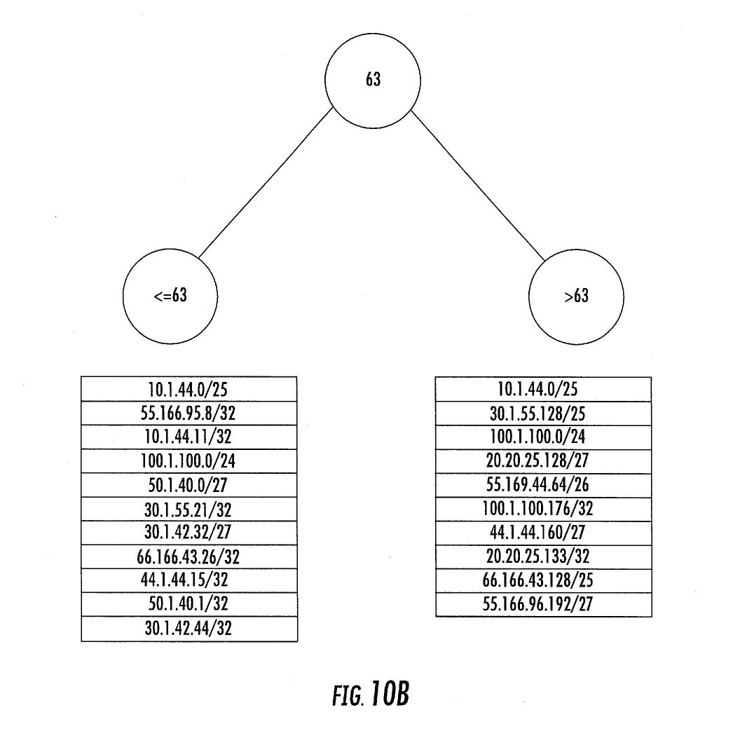

As with the example above, a distribution frequency for the values of the field being evaluated may be generated and, in one example, stored in a histogram structure. FIG. 10A illustrates an example of such a histogram structure. In FIG. 10A, histogram structure 700 is implemented using an array, where each array index may store multiple values relating to the distribution frequencies of the values of the field being evaluated. For example, at array index 0, there are 3 rules in the table in FIG. 8 whose “start” value is 0, i.e., the first rule, the fifth rule, and the seventh rule. Thus, 3 is stored in the “starts” element at array index 0. There are no rules whose “end value” is 0. Accordingly, the “end value” for array index 0 is equal to 0.

At any possible byte value, the entries which end at or before that value are to the left of that point. For example, at array index 21, the total number of “ends” is recorded as 5. In the graph illustrated in FIG. 9, a horizontal line is drawn through array index 21. There are 5 entries or rules that are less than or equal to 21. Another way of considering this count is that entries to the left are the total number ends at that point (if an entry's range had ended by a particular point, it must be to the left of that point).

The total number of entries or rules to the right of a particular value is equal to the total number of entries in the rules set minus the number of entries that are started by that value. The logic here is that if an entry has started by a particular point, then it is either to the left of the mark or it is a range that is spanning the mark. Again viewing array index 21, the total number of “starts” at 21 is 8 and the total number of entries is 19. Therefore, the total number of entries that are entirely to the right of 21 is 11. For example, “right” equals “total entries” minus “starts” (11=19−8).

At each point, some number of entries will go to the left and some number will go to the right. The goal is to find the value that gives the best split of the entries. An indication of the “best split” is when the list breaks into the shortest, evenly balanced legs. Compare the left and right at each index and determine the smaller of the two. For example, at index 21, left (total ends) is 5 and right equals 11. The smaller of these two numbers is 5 so record 5 as the min at index 21. Do this at each index and find the index where the min is greatest. At index 44 and 63, min equals 8. Of these two choices, the split at 44 is 8 left and 8 right. At 63 the split is 9 left and 8 right.

Is 63 better than 44 as the cut point? Keep in mind that these are the entries that are completely to the left or right. There are 19 total entries. The missing entries are actually on both sides of the index. In fact there are actually 3 entries that span 44, so using this index would create a tree with 11 entries on the left and 11 on the right because rule when span the cut value must be added to each child node. A cut of 63 has 2 entries that span it which gives a split of 11 left and 10 right.

We are looking for the best balance with the shortest legs. In this case, the best cut would be at 63. The reasoning is that a cut the produced 11 Left and 11 Right requires us to make up to 11 tests at the bottom of the tree. The cut that produces 11 Left and 10 right may only require 10 tests (rules matches) (if we are lucky). Since this chance exists, the tie goes to this cut. 11L, 10R is better than 11L, 11R based on fewer rules to check.

FIG. 10B illustrates an exemplary tree structure for the rules illustrated in FIG. 8 when 63 is selected as the cut value. In the illustrated example, the root node specifies the forth byte of the address and a cut value of 63. The left child node includes all rules with comparison field values<=63, and the right node includes all rules with comparison field values>63. As the example illustrated in FIG. 7B, the example illustrated in FIG. 10B shows the tree structure after only a single comparison field/cut value selection, such that the second level nodes in the tree are the leaf nodes. Notice that rules 1 and 5 are duplicated in the left and right child nodes as required by their spanning the cut value and needing to be in each child rule list. It is understood that the process of selecting comparison field/cut value combinations may be repeated for n levels of nodes, where n is an integer greater than or equal to 1 and chosen to achieve a particular tree depth and/or rule list size at the leaf nodes.

Assuming that the second level nodes in the tree are the leaf nodes as illustrated in FIG. 10B, if a packet arrives with the network address 55.166.96.200, rule matcher 107 will compare the last byte of the IP address (200 in this example) with the cut value of the root node. Because 200 is greater than 63, tree traversal proceeds down the right hand branch. The entire IP address in the packet is then compared to the rules associated with the right child node in priority order (from top to bottom in this example) to locate the matching rule with the highest priority. In this example, the only rule that matches is the last rule or 55.166.96.192/27. The total number of comparisons is 10, versus 20, which would be required if the rule were arranged as a linear set as illustrated in FIG. 8. Wildcards may be treated the same as ranges. For example, a wildcard on the last four bits of an IP address starting at 10.1.1.0 covers addresses ranging from 10.1.1.0 through 10.1.1.31. For this example, tree builder 110 would record the start value 0 and the end value of 31 for the wildcarded address. Tree builder 110 would then select the optimal cut value using the same method described above for ranges with respect for FIGS. 10A and 10B.

Although in the examples illustrated in FIGS. 7A and 10A, arrays are used to store the numbers of occurrences of the field values, the subject matter described herein is not limited to using arrays. Any suitable data structure for storing numbers of occurrences of field values and the relative values of the field values is intended to be within the scope of the subject matter described herein. In general, the structure for storing the numbers of occurrences of the comparison field values can be thought of as a type of histogram where each element in a row records the number of occurrences of a field value in a rule set.

### Definitions and Equations Used to Find Best Comparison Field/Cut Value Combination

The following definitions and equations are used in the array illustrated in FIG. 10A.

“Unique” refers to entries that are entirely to the left (<=) or entirely to the right (>) of the cut point. Thus, in FIG. 10A, at the cut point or value of 63, the number 9 in the “Unique Left” row means that there a 9 entries that start and end with a rule field value less than or equal to 63.

“Actual” includes all of the entries that are actually in each of the legs of list, including rules that have been split. Rules that have been split are included in both the left and right legs of the tree. For example, for the cut point 63, the rule 10.1.44.0/25 includes the range 0-127, which spans 63 and thus appears in both the left and right legs of the tree. Each leg includes not only the entries that are entirely to one side of a split, but also those entries that span the cut point.

“Ends” refers to a range that ends on a particular array index value. For example, in FIG. 10A, the value 1 at array index 63 indicates that 1 rule range ends on the value 63. “Unique Left” is the accumulation of Ends at a given array index. For example, the value 9 stored in the Unique Left row at array index 63 means that 9 ranges end on or before 63.

“Actual Left” is the same as “total starts” at each index. Any entry that starts to the left of an array index must be entirely to the left or spanning that index.

“Unique Right” is “Total Entries” minus “total starts”. (Given that “Actual Left”=“total starts”). In this example, there are 19 total entries. For array index 1, there are 4 total starts. Thus, Unique Right at array index 1 is equal to 19−4=15.

The following rules can also be used to describe and/or calculate the data in FIG. 10A:
Anything that is Actually Left cannot be Uniquely Right,

“Unique Right”=“Total Entries”−“Actual Left” or

“Unique Right”=“Total Entries”−“total starts”.
“Actual Right” is “Total Entries” minus “total ends”.
Any entry that is completely left cannot be right.

“Actual Right”=“Total Entries”−“Unique Left”

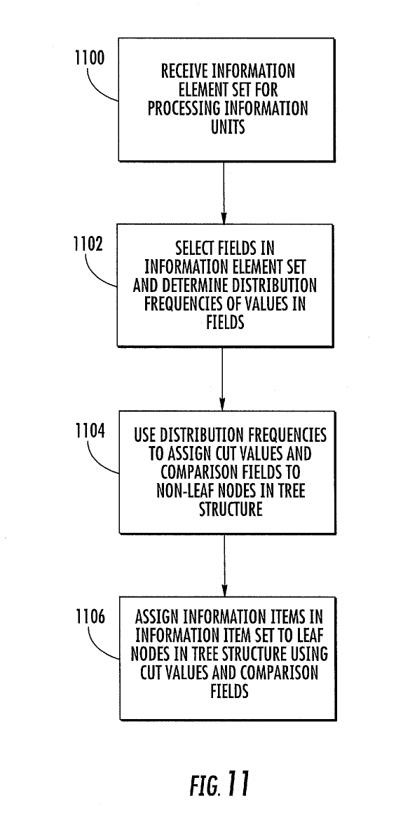

FIG. 11 is a flow chart illustrating an exemplary process for generating a tree structure with nodal comparison fields and cut values for rapid tree traversal and reduced numbers of full rule comparisons at leaf nodes according to an embodiment of the subject matter described herein.

Referring to FIG. 11, in step 1100, an information item set for processing information units is received. The information item set may include any suitable information items for processing information. In one example, the information item set may include packet processing rules.

In step 1102, fields in the information item set are selected and distribution frequencies of values of the fields are determined. As stated above, all fields or a subset of fields in an information item set may be evaluated to determine a comparison field/cut value combination that most evenly divides the information item set. For each field selected, an occurrence frequency value may be generated. In the examples described above, the distribution frequency is generated and embodied in a histogram structure

In step 1104, the distribution frequencies are used to assign comparison fields and cut values to non-leaf nodes in the tree structure. For each node in the tree structure, a comparison field and cut value may be selected that results in a balanced division of information items among child nodes. The comparison field and cut value combination is assigned to and stored in or otherwise associated with each non-leaf node. For each child node, the process of selecting a comparison field/cut value combination is repeated based of the respective information items subset. The process may be repeated a number of times based on the desired level of information item set optimization, the hardware or software implementation of the information item set, etc. For example, it may be desirable to build a tree such that the maximum or average number of information items at the leaf nodes is less than or equal to a predetermined value. In another example, it may be desirable to divide the information item set until the tree reaches a predetermined depth. In yet another example, it may be desirable to divide the information item set until further divisions will not yield lower numbers of information items at the leaf nodes. Any one or more of such optimizations may be performed without departing from the scope of the subject matter described herein.

Once the desired optimization has been achieved, information items from the information item set are assigned to leaf nodes in the tree (step 1106). The information items assigned to each leaf node depend on the comparison fields and cut values of the branch of the tree that leads to each leaf node. Using the example in FIG. 3, the information item subset assigned to the leftmost leaf node depends on the comparison fields and cut values of all of the nodes from the root node leading to the leaf node. As stated above, the information items in the information item set assigned to the leaf nodes may be subsets of the original information item set so that the number of full information item comparisons that are performed at the leaf nodes is reduced over that of the original information item set. The information items may be stored physically or logically in the leaf nodes or separately from the leaf nodes. Priority of the information items in the subset at each leaf node is maintained logically, virtually, explicitly or implicitly.

Many of the examples described herein relate to a “rule matching” technique as example of matching or processing IUs to associated rules lists. Those skilled in the art of matching objects, rules, lists, tables or generally any type objects sets and also object sets with priority will recognize that the lookup/matching capabilities described herein have other uses well beyond rules matching for packet processing. List, ordered list, priority list and data set matching are common events in data processing of all types and the use of the tree generation techniques described herein to subdivide large data sets to smaller sets for faster processing for these and other applications is intended to be within the scope of the subject matter described herein.

Thus, the subject matter described herein improves the technological field of information processing, including packet processing, by creating a tree with comparison fields and cut values that achieve division of rules among child nodes of the tree. Such a tree structure improves the functionality of the processing computer itself by reducing the number of comparisons and the lookup time for locating a matching rule or data set. A computing device, such as a packet processing device, when configured with a tree builder, tree traverser rules tree, and a rule matcher as described herein, becomes a special purpose computing device for processing of information units or packets

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for generating a tree structure, the method comprising:
in a computing device including a processor and a memory:
receiving, by the processor, an information item set for processing information units;
selecting, by the processor, at least one field in the information item set and determining at least one distribution frequency of values of the at least one field in the information item set;
using, by the processor, the at least one distribution frequency of values to assign at least one comparison field and cut value combination to at least one non-leaf node in the tree structure; and
assigning, by the processor, information items in the information item set to leaf nodes in the tree structure using the at least one comparison field cut value and the combination.

2. The method of claim 1 wherein the information item set is a prioritized information item set.

3. The method of claim 1 wherein selecting the at least one field includes identifying a combination of one or more bits in the information item set

4. The method of claim 1 wherein determining the at least one distribution frequency includes generating at least one histogram structure that stores values indicative of the numbers of occurrences of the values in the information item set.

5. The method of claim 4 wherein using the at least one distribution frequency to assign the at least one comparison field and cut value combination to the at least one non-leaf node includes using the at least one histogram structure to assign the at least one comparison field and cut value combination to the at least one non-leaf node.

6. The method of claim 5 wherein the at least one histogram structure comprises at least one array.

7. The method of claim 6 wherein the at least one array stores numbers of occurrences of the values of the at least one field at indices corresponding to values of the at least one field.

8. The method of claim 7 wherein assigning the information items in the information item set to the leaf nodes includes:
traversing the at least one array and accumulating at least one count of the numbers of occurrences of the values of the at least one field; and
selecting the at least one comparison field and cut value combination using the at least one accumulated count and a manner in which corresponding values in the array divide the information items in the information item set.

9. The method of claim 1 wherein at least one information item of the information item set specifies a range of values for at least one field of the information item, and wherein generating the at least one distribution frequency includes recording only a start value and an end value for the range.

10. The method of claim 9 wherein assigning the at least one comparison field and cut value combination to the at least one non-leaf node includes recording counts of ranges that end before, after, and that include each of the values of the field and selecting the at least one comparison field and cut value combination that most evenly balances the information items among child nodes of the at least one non-leaf node.

11. The method of claim 1 wherein assigning the information items to the leaf nodes includes assigning subsets of the information items in the information item set to the leaf nodes, where the subset assigned to each leaf node is determined using the at least one comparison field and cut value combination in at least one node of the tree structure leading to the leaf nodes.

12. The method of claim 1 wherein the computing device comprises a packet processing device, wherein the information items comprise packet processing rules, and wherein the information units comprise packets or portions thereof.

13. A system for generating a tree structure, the system comprising:
a computing device including a processor and a memory; and a tree builder implemented by the processor for:
receiving an information item set for processing information units;
selecting at least one field in the information item set and determining at least one distribution frequency of values of the at least one field;
using the at least one distribution frequency to assign at least one comparison field and cut value combination to at least one non-leaf node in the tree structure; and
assigning information items in the information item set to leaf nodes in the tree structure using the at least one cut value and the comparison field combination.

14. The system of claim 13 wherein the information item set is a prioritized information item set.

15. The system of claim 13 wherein selecting the at least one field includes identifying a combination of one or more bits in the information item set.

16. The system of claim 13 wherein determining the at least one distribution frequency includes generating at least one histogram structure that stores values indicative of the numbers of occurrences of the values in the information item set.

17. The system of claim 16 wherein using the at least one distribution frequency to assign the at least one comparison field and cut value combination to the at least one non-leaf node includes using the at least one histogram structure to assign the at least one comparison field and cut value combination to the at least one non-leaf node.

18. The system of claim 17 wherein the at least one histogram structure comprises at least one array.

19. The system of claim 18 wherein the at least one array stores numbers of occurrences of the values of the at least one field at indices corresponding to values of the at least one field.

20. The system of claim 19 wherein assigning the information items in the information item set to the leaf nodes includes:
traversing the at least one array and accumulating at least one count of the numbers of occurrences of the values of the at least one field; and
selecting the at least one comparison field and cut value combination using the at least one accumulated count and a manner in which corresponding values in the array divide the information items in the information item set.

21. The system of claim 13 wherein at least one information item of the information item set specifies a range of values for at least one field of the information item, and wherein generating the at least one distribution frequency includes recording only a start value and an end value for the range.

22. The system of claim 21 wherein assigning the at least one comparison field and cut value combination to the at least one non-leaf node includes recording counts of ranges that end before, after, and that include each of the values of the field and selecting the at least one comparison field and cut value combination that most evenly balances the information items among child nodes of the at least one non-leaf node.

23. The system of claim 13 wherein assigning the information items to the leaf nodes includes assigning subsets of the information items in the information item set to the leaf nodes, where the subset assigned to each leaf node is determined using the at least one comparison field and cut value combination in at least one node of the tree structure leading to the leaf nodes.

24. The system of claim 13 wherein the computing device comprises a packet processing device, wherein the information items comprise packet processing rules, and wherein the information units comprise packets or portions thereof.

25. A non-transitory computer readable medium having stored thereon executable instructions that when executed by the processor of a computer control the computer to perform steps comprising:
receiving, by the processor, an information item set for processing information units;
selecting, by the processor, at least one field in the information item set and determining at least one distribution frequency of values of the at least one field;
using, by the processor, the at least one distribution frequency to assign at least one comparison field and cut value combination to at least one non-leaf node in the tree structure; and
assigning, by the processor, information items in the information item set to leaf nodes in the tree structure using the at least one cut value and the comparison field combination.
